(19) United States
(12) Patent Application Publication
(10) Pub. No.: US 2015/0277500 A1
(43) Pub. Date: Oct. 1, 2015

(54) Peripheral Device Storage

(71) Applicant: Microsoft Corporation, Redmond, WA (US)

(72) Inventors: Daniel J. Turowski, Kirkland, WA (US); Joseph B. Gault, Seattle, WA (US)

(73) Assignee: Microsoft Corporation, Redmond, WA (US)

(21) Appl. No.: 14/229,507

(22) Filed: Mar. 28, 2014

(51) Int. Cl. G06F 1/16

(52) U.S. Cl. CPC G06F 1/1656; G06F 1/1626; G06F 1/1684

(57) ABSTRACT

A peripheral retention device and related techniques are described. In one or more implementations, a computing device includes a housing having a display device secured thereto, the housing configured to be held by one or more hands of a user, one or more computing components are disposed within the housing, and a peripheral retention device secured to the housing. The peripheral retention device includes a flexible retractable portion that is configured to retract toward a surface of the housing and extend away from the surface of the housing to receive and retain a peripheral device between the retractable portion and the housing. The peripheral device is configured to support user interaction with a user interface output by the display device.

### BACKGROUND

Tablet computing devices sometimes include alternative input devices, such as a stylus. Storing of a stylus, however, may create a couple of design challenges. There are two conventional solutions to this problem. In a first example, an internal slot is used to store and retain the stylus through friction or through a push-push type mechanism.

This may create a problem where extra space and parts are required inside the device. This may also cause an increase in the complexity of the device, overall size of the device which may be undesirable for mobile configurations, and may therefore hinder the user's experience with the device.

In another example a lanyard and a pen cap are used. This conventional solution may also create problems. The lanyard, for instance, may operate somewhat as an uncontrolled appendage and therefore get caught on other objects, pen caps tend to let the pen fall out due to limitations of a retention force that may be used, and so on.

### SUMMARY

A peripheral retention device and related techniques are described. In one or more implementations, a computing device includes a housing having a display device secured thereto, the housing configured to be held by one or more hands of a user, one or more computing components are disposed within the housing, and a peripheral retention device secured to the housing. The peripheral retention device includes a flexible retractable portion that is configured to retract toward a surface of the housing and extend away from the surface of the housing to receive and retain a peripheral device between the retractable portion and the housing. The peripheral device is configured to support user interaction with a user interface output by the display device.

In one or more implementations, a device includes a housing, one or more computing components disposed within the housing, and a peripheral retention device secured to the housing. The peripheral retention device includes a channel formed in the housing and a retractable portion that is disposed over the channel and configured to assume a secure position to secure a peripheral device between the retractable portion and the channel and a retracted position in which at least part of the retractable portion that is configured to retract at least partially into the channel when not securing the peripheral device.

In one or more implementations, a system includes a stylus and a computing device. The computing device includes a housing having a hand-held configuration and a peripheral retention device secured to the housing and including a flexible retractable portion that is configured to retract toward a surface of the housing and extend away from the surface of the housing to retain the stylus between the retractable portion and the housing.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ the techniques described herein to secure a peripheral device.

FIG. 2 depicts a side view of a housing of a computing device of FIG. 1 showing an example of a peripheral retention device.

FIG. 3 depicts a side view of a housing of a computing device of FIG. 1 showing the example of a peripheral retention device of FIG. 2 as securing a peripheral device configured as a stylus.

FIG. 4 depicts an example implementation in which the stylus of FIG. 3 engages the peripheral retention device to secure the stylus to the housing of the computing device.

FIG. 5 depicts a view taken along an end of the side of the housing of the example implementation of the computing device of FIG. 3.

FIG. 6 depicts a cross section view taken along a longitudinal axis of the peripheral retention device of the computing device and the stylus.

FIG. 7 depicts an example implementation in which the computing device includes the peripheral retention device and a kickstand mechanism.

FIG. 8 depicts an example implementation in which the peripheral retention device is disposed proximal to a kickstand mechanism of FIG. 7.

FIG. 9 illustrates an example system including various components of an example device that can be implemented as any type of computing device as described with reference to FIGS. 1-8 to implement embodiments of the techniques described herein.

### DETAILED DESCRIPTION

### Overview

Computing devices may employ a wide range of peripheral devices to support different types of user interaction with the device. This may include input devices that are configured to be used in addition to the computing device, an example of which is a stylus. However, conventional techniques that were utilized to store peripheral devices were often cumbersome and hindered a user's interaction with both the peripheral device and the computing device.

Peripheral retention device techniques are described. In one or more implementations, a computing device includes a peripheral retention device that is configured to secure a peripheral device, such as a stylus or other input/output device, external power supply, head phones, and so on, to the computing device. The peripheral retention device, for instance, may include a flexible retractable portion and a channel formed in a housing of the computing device. The flexible retractable portion may be configured to retract within the housing when not in use such that the device does not hinder user interaction with the computing device as could be encountered using conventional techniques, e.g., lanyards.

A user may secure the peripheral device, such as a stylus in this example, by positioning an end of the device within the channel and then sliding the stylus along the channel. This may cause the flexible retractable portion to extend away from the housing, thereby positioning the stylus in a loop formed between the flexible retractable portion and the channel. In this way, the stylus may be quickly secured and removed using a single hand of a user, thereby promoting portability of the computing device. Further discussion of these and other examples may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

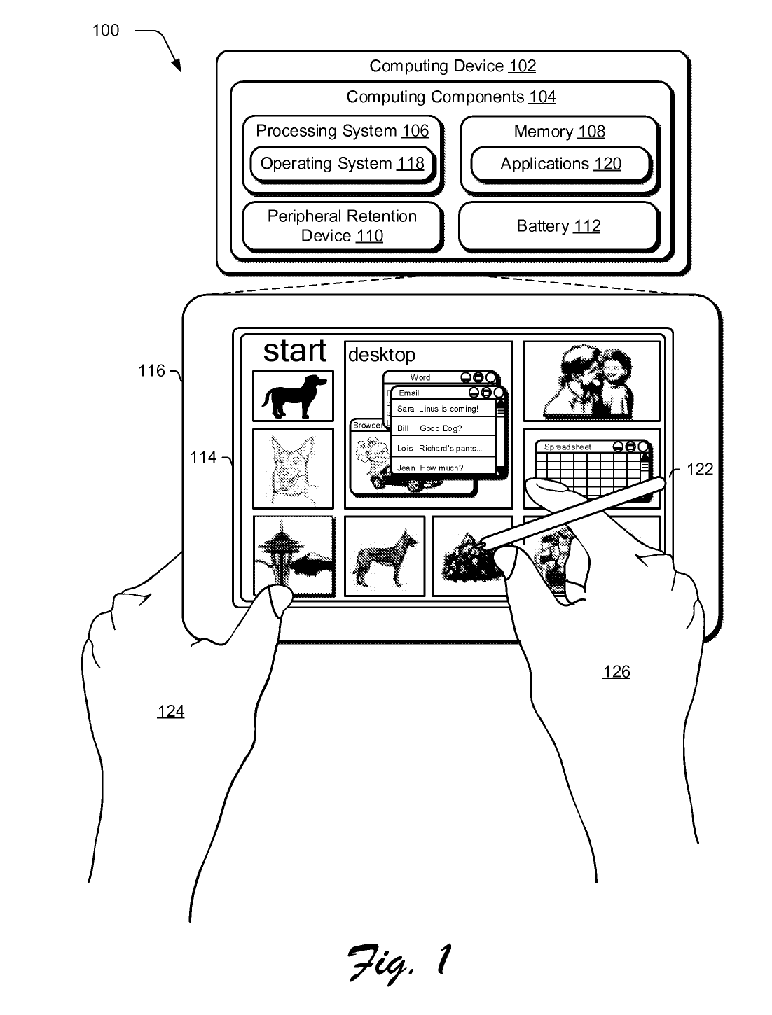

FIG. 1 is an illustration of an environment 100 in an example implementation that is operable to employ techniques described herein. The illustrated environment 100 includes a computing device 102 having a plurality of computing components 104 that are implemented at least partially in hardware. Illustrated examples of these computing components 104 include a processing system 106 and a computer-readable storage medium that is illustrated as a memory 108, a peripheral retention device 110, battery 112, and display device 114 that are disposed within and/or secured to a housing 116. Examples of software that is executable on the processing system 106 and storable in memory 108 include an operating system 118 and applications 120.

The computing device 102 may be configured in a variety of ways. For example, a computing device may be configured as a computer that is capable of communicating over a network, such as a desktop computer, a mobile station, an entertainment appliance, a set-top box communicatively coupled to a display device, a wireless phone, a game console, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles).

The computing device 102 is further illustrated as including an operating system 118. The operating system 118 is configured to abstract underlying functionality of the computing device 102 to applications 120 that are executable on the computing device 102. For example, the operating system 118 may abstract the computing components 104 of the computing device 102 such that the applications 120 may be written without knowing “how” this underlying functionality is implemented. The application 120, for instance, may provide data to the operating system 118 to be rendered and displayed by the display device 114 without understanding how this rendering will be performed, may receive inputs detected using touchscreen functionality of the display device 114, and so on. The operating system 118 may also represent a variety of other functionality, such as to manage a file system and user interface that is navigable by a user of the computing device 102.

The computing device 102 may support a variety of different interactions. For example, the computing device 102 may include one or more hardware devices that are manipulable by a user to interact with the device, which may include peripheral devices such as a keyboard, cursor control device (e.g., mouse), a stylus 122 and so on.

In the illustrated example, first and second hands 124, 126 of a user are shown. The first hand 124 of the user is shown as holding a housing 116 of the computing device 102. The second hand 126 of the user is illustrated as providing one or more inputs using the stylus 122 that are detected using touchscreen functionality of the display device 114 to perform an operation, such as to launch an application. Thus, recognition of the inputs may be leveraged to interact with a user interface output by the computing device 102, such as to interact with a game, an application, browse the internet, change one or more settings of the computing device 102, and so forth. Although a stylus 122 is shown, a variety of other peripheral devices are also contemplated, such as a mouse or other cursor control device, output device, external power supply, and so on.

Peripheral devices such as the illustrated stylus 122 may be lost in some instances by a user because the device is not physically attached to the computing device 102, especially in handheld (i.e., mobile) configurations of the computing device 102. However, conventional techniques that were utilized to secure the stylus to the computing device 102 could consume inordinate amounts of room within a housing 116 (e.g., by internal slot is used to store and retain the stylus through friction or through a push-push type mechanism), interfere with a user's interaction with a device (e.g., a lanyard), and so forth. Accordingly, the peripheral retention device 110 may be configured to secure the stylus 122 or other peripheral device to the housing 116 in a manner that does not interfere with a user's interaction with the computing device 102. An example of one such configuration is described as follows and shown in a corresponding figure.

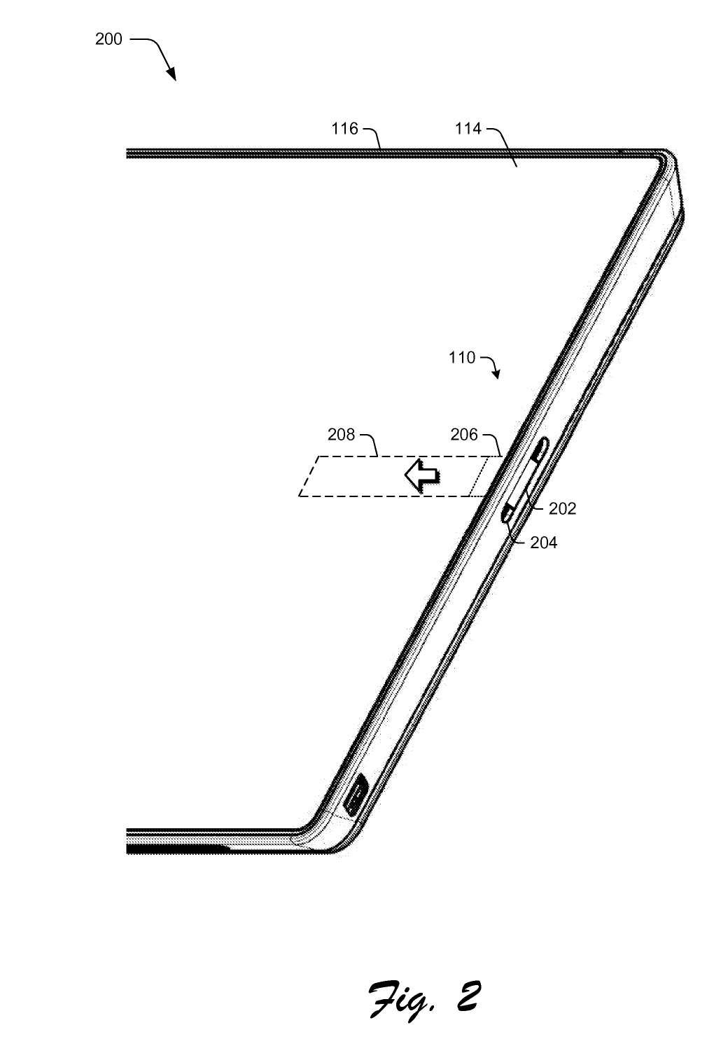

FIG. 2 depicts a side view 200 of the housing 116 of the computing device 102 of FIG. 1 showing the peripheral retention device 110 in greater detail. In this side view, a right side of the housing 116 of FIG. 1 is illustrated which includes the peripheral retention device 110 formed as having a retractable portion 202 and a channel 204. The retractable portion 202 in this case is flexible such that the portion may conform to an object being retained by this portion. Other examples, naturally, are also contemplated including examples in which the portion is not flexible, is molded to conform to an outer surface of a peripheral device to be retained, and so on.

The retractable portion 202 in this example has two sections, a flexible section 206 that is not elastic and an elastic section 208 that is configured to provide a retention force of the retractable portion 204. The retractable portion 202 is illustrated as retracted toward the housing to assume a retracted position. The elastic section 208, for instance, may provide a biasing force that causes an external portion of the retractable portion 202 to be forced toward a surface of the housing 116, and in the case a channel 204 formed in the housing 116. Other configurations for biasing are also contemplated without departing from the spirit and scope thereof.

When in this position, an exposed end of the retractable portion 202 is configured as relatively flush with an edge of an opening of the channel 204 in the housing. In this way, the retractable portion 202 may reduce snagging and other interference as was caused using conventional techniques, e.g., lanyards.

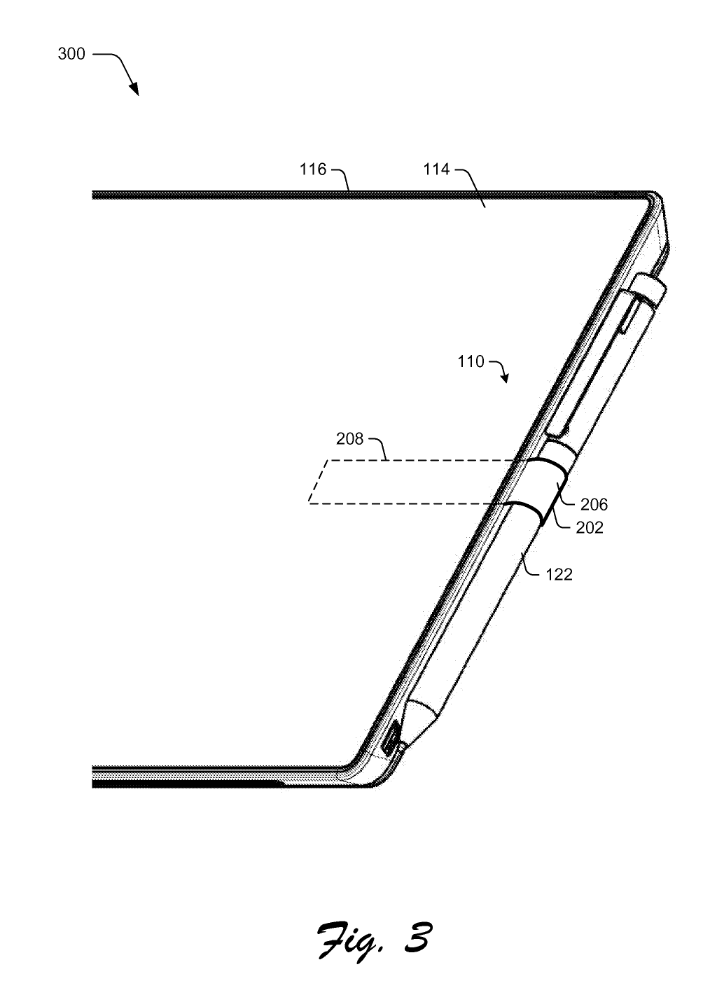

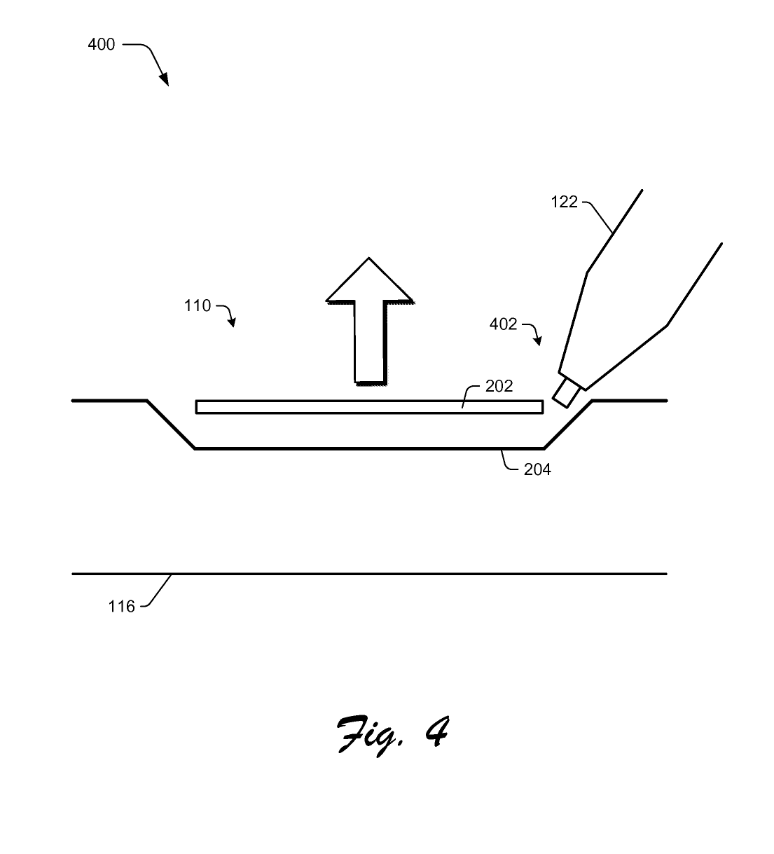

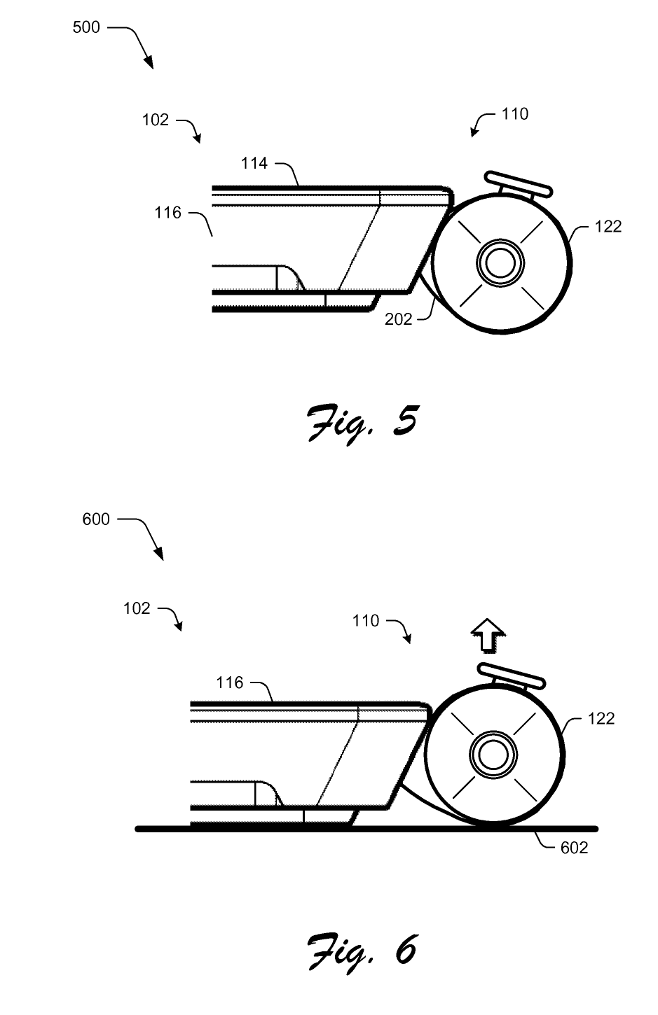

FIG. 3 illustrates an implementation 300 depicting the side view 200 of the housing 120 of the computing device 102 of FIG. 2 as securing the stylus 122 using the peripheral retention device 110. The stylus 122 of FIG. 1 is shown as being secured against the housing 116. This may be performed using the biasing force of the elastic section 208 of the retractable portion 202 or other configuration, e.g., a spring, motorized force, and so forth.

Thus, the stylus 122 is secured between the retractable portion 204 of the peripheral retention device 110 and the channel 204 of FIG. 2 that is formed in the housing 116. In this way, the stylus 122 may be secured and made readily accessible to a user without needlessly consuming valuable internal space of the housing 116 by disposing all or part of the peripheral device 114 within the housing 116 as is common using conventional techniques. The peripheral retention device 110 may be configured in a variety of ways to assist securing of the peripheral device such as the stylus 122, such as to support one-handed operation, an example of which is described as follows and shown in a corresponding figure.

FIG. 4 depicts an example implementation 400 in which the stylus 122 engages the peripheral retention device 110 to secure the stylus 122 to the housing 116 of the computing device 102. In this example, an end 402 of the stylus 122 is disposed within the channel 204 formed in the housing 116. The stylus 122 may then be slid through the channel 204, thereby causing the retention portion 202 to extend away from the housing 116 upon contact with the stylus 122, which is illustrated through use of an arrow in the figure.

In this way, a single one of the user's hands 124, 126 may grasp the stylus 122 and secure it to the computing device 102 using the peripheral retention device 110. It should be readily apparent that a wide variety of other examples are also contemplated. A design of the housing 116 in relation the peripheral retention device 110 may also aid in protecting the peripheral device, an example of which may be found in relation to the following figure.

FIG. 5 depicts a view 500 taken along an end of the side of the housing 116 of the example implementation 300 of the computing device 102 of FIG. 3. As illustrated, the side surface of the housing 116 forms an angle, e.g., 26.5 degrees. In this example, this angle is formed such that a top surface of the computing device 102 that includes the display device 114 is larger than a rear surface of the computing device 102 disposed on an opposing side of the display device 114.

The stylus 122 is illustrated as secured against the side surface of the housing 120 using the retractable portion 202 of the peripheral retention device 110. Because the side surface forms an angle, the stylus 122 is protected against inadvertent contact from forces approaching from the top surface of the housing. However, the stylus 122 may also be easily grasped by the fingers of a user's hand when approaching the stylus 122 from the rear surface of the housing 120. In this way, both protection and ease of interaction with the secured peripheral device are promoted.

FIG. 6 depicts a cross section view 600 taken along a longitudinal axis of the peripheral retention device 110 of the computing device 102 and the stylus 122. In this example, the housing 116 of the computing device 102 rests against a surface 602, such as a table top, desk, and so on.

The peripheral retention device 102, through ability to extend away from the housing 116, permits the stylus 122 to move away from the surface 602, as illustrated by the arrow. Thus, even though the computing device 102 is thinner than the stylus 122 in this example the computing device 102 may still “rest flat” against the surface 602 through movement of the stylus 122 permitted by the peripheral retention device 110.

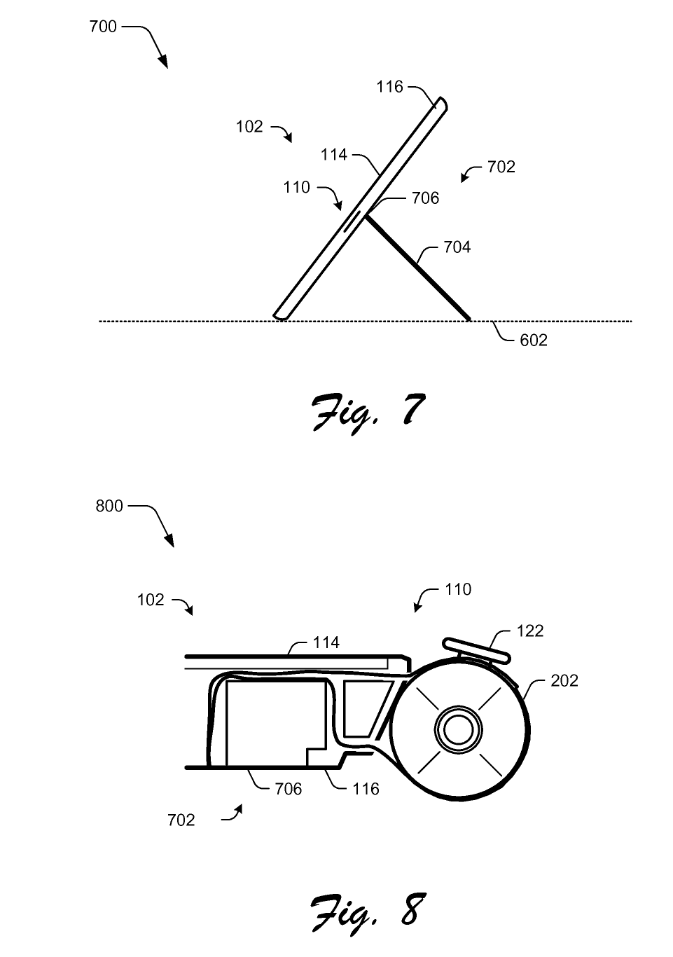

FIG. 7 depicts an example implementation 700 in which the computing device 102 includes the peripheral retention device 110 and a kickstand mechanism 702. As previously described, the computing device 102 may be configured in a variety of ways. In this example, the computing device 102 has a housing 116 configured according to a handheld form factor, e.g., a tablet, mobile phone, and so on.

The housing 116 also includes a kickstand mechanism 702 such that the computing device 102 is positioned to permit viewing of the display device 114 when resting on the surface 602. The kickstand mechanism 702 includes a kickstand 704 and a hinge 706 that are configured to permit the kickstand 704 to move between an extended position as illustrated and a stored position against a back of the housing 116. The peripheral retention device 110 may be configured to leverage space surrounding the kickstand mechanism 702 to further conserve space within the housing 116, an example of which is described as follows and shown in a corresponding figure.

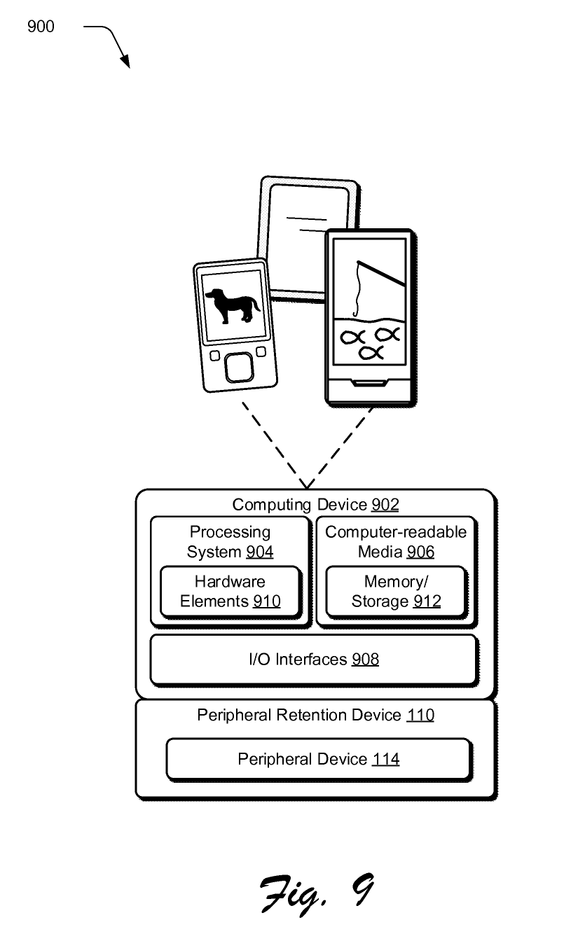

FIG. 8 depicts an example implementation 800 in which the peripheral retention device 110 is disposed proximal to kickstand mechanism 702 of FIG. 7. A cross section of the hinge 706 is shown in this figure. The retention portion 202 is disposed through an opening in the housing 116 and passes between the hinge 706 and the display device 114. The retention portion 202 is then secured (e.g., anchored) to the housing 116. Thus, in this example the peripheral retention device 102 reduces consumption of additional space within the housing 116 and thereby promotes a handheld (e.g., mobile) form factor. Other examples are also contemplated without departing from the spirit and scope thereof.

### Example System and Device

FIG. 9 illustrates an example system generally at 900 that includes an example computing device 902 that is representative of one or more computing systems and/or devices that may implement the various techniques described herein. The computing device 902 may be, for example, be configured to assume a mobile configuration through use of a housing formed and size to be grasped and carried by one or more hands of a user, illustrated examples of which include a mobile phone, mobile game and music device, and tablet computer although other examples are also contemplated.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways to support user interaction.

The computing device 902 is further illustrated as being physically coupled to a peripheral device 914 that is physically removable from the computing device 902, e.g., using magnetism. In this way, a variety of different input devices may be coupled to the computing device 902 having a wide variety of configurations to support a wide variety of functionality.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A computing device comprising:
a housing including a display device secured thereto, the housing configured to be held by one or more hands of a user;
one or more computing components disposed within the housing; and
a peripheral retention device secured to the housing and including a flexible retractable portion that is configured to:
retract toward a surface of the housing; and
extend away from the surface of the housing to receive and retain a peripheral device between the retractable portion and the housing, the peripheral device configured to support user interaction with a user interface output by the display device.

2. A computing device as described in claim 1, wherein the peripheral retention device includes a channel disposed within the housing.

3. A computing device as described in claim 2, wherein the channel is configured to receive an end of the peripheral device with subsequent sliding movement of the peripheral device through the channel causing the flexible retractable portion to extend away from the surface of the housing.

4. A computing device as described in claim 1, wherein the peripheral retention device is configured to be relatively flush with a side of the housing that includes the surface when retracted without retaining the peripheral device.

5. A computing device as described in claim 1, wherein the peripheral retention device includes an elastic material configured to cause the retraction toward the surface of the housing and the retention of the peripheral device.

6. A computing device as described in claim 5, wherein the peripheral retention device further includes a flexible section that is not elastic.

7. A computing device as described in claim 6, wherein the flexible section that is not elastic is configured to contact the peripheral device when retained by the peripheral retention device.

8. A computing device as described in claim 1, wherein the peripheral retention device is configured to support movement of the peripheral device away from a surface when the housing rests against the surface.

9. A computing device as described in claim 1, wherein the peripheral device is configured as a stylus.

10. A device comprising:
a housing;
one or more computing components disposed within the housing; and
a peripheral retention device secured to the housing and including:
a channel formed in the housing;
a retractable portion that is disposed over the channel and configured to assume:
a secure position to secure a peripheral device between the retractable portion and the channel; and
a retracted position in which at least part of the retractable portion that is configured to retract at least partially into the channel when not securing the peripheral device.

11. A device as described in claim 10, wherein the channel is configured to receive an end of the peripheral device with subsequent sliding movement of the peripheral device through the channel causing the flexible retractable portion to extend away from the surface of the housing.

12. A device as described in claim 10, wherein the peripheral retention device is biased towards the retracted position.

13. A device as described in claim 10, wherein the peripheral retention device includes an elastic material configured to cause the retraction toward the surface of the housing and the retention of the peripheral device.

14. A device as described in claim 13, wherein the peripheral retention device further includes a flexible section that is not elastic.

15. A device as described in claim 14, wherein the flexible section that is not elastic is configured to contact the peripheral device when retained by the peripheral retention device.

16. A device as described in claim 14, wherein the peripheral device is a stylus.

17. A system comprising:
a stylus; and
a computing device including a housing having a hand-held configuration and a peripheral retention device secured to the housing and including a flexible retractable portion that is configured to retract toward a surface of the housing;
and extend away from the surface of the housing to retain the stylus between the retractable portion and the housing.

18. A system as described in claim 17, wherein the stylus is configured to support user interaction with a user interface output by a display device of the computing device.

19. A system as described in claim 18, wherein the interaction is supported using touchscreen functionality.

20. A system as described in claim 17, wherein the computing device is a mobile phone or tablet computer.
